(19) United States
(12) Patent Application Publication
(10) Pub. No.: US 2013/0312732 A1
(43) Pub. Date: Nov. 28, 2013

(54) GAS AND CERAMIC GRILL COMBINATION

(71) Applicant: Robert Anthony Brennan, Duluth, GA (US)

(72) Inventor: Robert Anthony Brennan, Duluth, GA (US)

(21) Appl. No.: 13/901,058

(22) Filed: May 23, 2013

Related U.S. Application Data
(60) Provisional application No. 61/650,476, filed on May 23, 2012.

(51) Int. Cl. A47J 37/07

(52) U.S. Cl. CPC A47J 37/07
USPC 126/25 R; 99/339

(57) ABSTRACT

In various embodiments a gas and ceramic grill combination is provided. The assembly includes a cart adapted to receive a Kamado grill. Additionally the assembly is adapted to provide a gas burner grill, storage, and removable flip-up side shelves. A sear burner is provided for some embodiments. In at least one embodiment the frame structure for the combination may be configured for separation and combining of the gas grill frame and the charcoal grill frame. The combination grill is one integrally formed structure in one embodiment. In an alternative embodiment, the combination grill includes two separate structures that are adapted to be joined one to another.

### CROSS-REFERENCE TO RELATED APPLICATION(S)

The present non-provisional patent application claims the benefit of priority of U.S. Provisional Patent Application No. 61/650,476, which is entitled “GAS AND CERAMIC GRILL COMBINATION”, which was filed on M, 2012, and which is incorporated in full by reference herein.

### FIELD OF THE INVENTION

The technology described herein relates generally to the field of cooking grills. More specifically, the technology relates to gas and ceramic grills. Still furthermore, the technology relates to combination gas and ceramic grill. The combination grill is one integrally formed structure in one embodiment. In an alternative embodiment, the combination grill includes two separate structures that are adapted to be joined one to another.

### BACKGROUND OF THE INVENTION

A barbecue grill is a device for cooking food by applying heat directly from below. There are several varieties of such grills, with most falling into one of two categories: gas-fueled and charcoal. There is a great debate over the merits of charcoal or gas for use as the cooking method between barbecue grillers.

Barbecuing is a pervasive tradition in much of the world. Almost all competition grillers use charcoal, most often in large, custom designed brick or steel grills. They can range from a few 55 gallon oil drums sawed lengthwise on their sides to make a lid and grill base, to large, vehicle sized grills made of brick, weighing nearly a ton.

Gas-fueled grills typically use propane (LP) or natural gas (NG) as their fuel source, with gas-flame either cooking food directly or heating grilling elements which in turn radiate the heat necessary to cook food. Gas grills are available in sizes ranging from small, single steak grills up to large, industrial sized restaurant grills which are able to cook enough meat to feed a hundred or more people. Gas grills are designed for either LP or NG, although it's possible to convert a grill from one gas source to another.

The majority of gas grills follow the cart grill design concept: the grill unit itself is attached to a wheeled frame that holds the fuel tank. The wheeled frame may also support side tables and other features.

A recent trend in gas grills is for the manufacturers to add an infrared radiant burner to the back of the grill enclosure. This radiant burner provides an even heat across the burner and is intended for use with a horizontal rotisserie. A meat item (whole chicken, beef roast, pork loin roast) is placed on a metal skewer that is rotated by an electric motor. Smaller cuts of meat can be grilled in this manner using a round metal basket that slips over the metal skewer.

Another type of gas grill gaining popularity is called a flattop grill. According to Hearth and Home magazine, flattop grills “on which food cooks on a griddle-like surface and is not exposed to an open flame at all” is an emerging trend in the outdoor grilling market.

A small metal “smoker box” containing wood chips may be used on a gas grill to give a smoky flavor to the grilled foods. Although, barbecue purists would argue that to get a true smoky flavor (and smoke ring) you have to cook low and slow, indirectly and using wood or charcoal. According to The Gas Grill Review and Ratings Guide, gas grills are difficult to maintain at the low temperatures required (˜225-250° F.), especially for extended periods.

The kettle grill is considered the classic American grill design. The original and often-copied Weber kettle grill was invented in 1951 by George Stephen. It has remained one of the most commercially successful charcoal grill designs to date. Smaller and more portable versions exist, such as the Weber Smokey Joe. The kettle grill is composed of a lid, cooking grid, charcoal grid, lower chamber, venting system, and legs. Some models include an ash catcher pan and wheels. The lower chamber that holds the charcoal is shaped like a kettle, giving the grill its name. The key to the kettle grills' cooking abilities is its shape. The kettle design distributes heat more evenly. When the lid is placed on the grill, it prevents flare-ups from dripping grease, and allows heat to circulate around the food as it cooks. It also holds in flavor-enhancing smoke produced by the dripping grease or from smoking wood added to the charcoal fire.

The kettle design allows the griller to configure the grill for indirect cooking (or barbecuing) as well. For indirect cooking, charcoal is piled on one or both sides of the lower chamber and a water pan is placed in the empty space to one side or between the charcoals. Food is then placed over the water pan for cooking. The venting system consists of one or more vents in the bottom of the lower chamber and one or more vents in the top of the lid. Normally, the lower vent(s) are to be left open until cooking is complete, and the vent(s) in the lid are adjusted to control airflow. Restricted airflow means lower cooking temperature and slower burning of charcoal.

The ceramic cooker design has been around for roughly 3,000 years. The shichirin, a Japanese grill traditionally of ceramic construction, has existed in its current form since the Edo period however more recent designs have been influenced by the mushikamado now more commonly referred to as a kamado. Recently, the kamado ceramic cooker design has been made popular by the Grill Dome, Komodo, Kamado, the Big Green Egg, and Primo. The ceramic cooker is more versatile than the kettle grill but the ceramic chamber retains heat and moisture more efficiently. Ceramic cookers are equally adept at grilling, smoking, and barbecuing foods.

A gas grill burner is the central source of heat for cooking food. Gas grill burners are typically constructed of: stainless steel, aluminized steel, and/or cast iron (occasionally porcelain-coated).

Burners are hollow with gas inlet holes and outlet ‘ports’. For each inlet is a separate control on the control panel of the grill. The most common type of gas grill burners are called ‘H’ burners and resemble the capital letter ‘H’ turned on its side. Another popular shape is oval. There are also ‘Figure 8’, ‘Bowtie’ and ‘Bar’ burners. Other grills have a separate burner for each control. These burners can be referred to as ‘Pipe’, ‘Tube’, or ‘Rail’ burners. They are mostly straight since they are only required to heat one portion of the grill.

Gas is mixed with air in venturi tubes or simply ‘venturis’. Venturis can be permanently attached to the burner or removable. At the other end of the venturi is the gas valve, which is connected to the control knob on the front of the grill.

A metal screen covers the fresh air intake of each venturi to keep spiders from clogging the tube with their nests.

Related patents known in the art include the following:

U.S. Pat. No. 4,819,614, issued to Hitch on Apr. 11, 1989, discloses a duel fuel barbecue grill.

U.S. Pat. No. 5,878,739, issued to Guidry on Mar. 9, 1999, discloses a combination gas and charcoal grill.

U.S. Pat. No. 6,000,389, issued to Alpert on Dec. 14, 1999, discloses a combination gas and charcoal grill.

U.S. Pat. No. 6,173,644, issued to Krall on Jan. 16, 2001, discloses an apparatus for converting a gas grill into a charcoal burning grill.

U.S. Pat. No. 6,640,800, issued to Hodgson et al. on Nov. 4, 2003, discloses a multiple fuel cooking apparatus.

U.S. Pat. No. 7,273,261, issued to DeMars on Sep. 25, 2007, discloses a portable bar with portable barbecue.

U.S. Pat. No. 7,832,390, issued to Hsu et al. on Nov. 16, 2010, discloses a cooking apparatus with burning drawers that may be removed and exchanged so that it can be either natural gas, or wood or charcoal.

Related published patent applications known in the art include the following:

U.S. Published Patent No. 2002/0033172, Inventor Ruiz, published on Mar. 21, 2002, discloses a bar-grill-cooler.

U.S. Published Patent No. 2008/0066733, Inventor Wahl et al., published on Mar. 20, 2008, discloses a combination gas grill, charcoal grill, and smoker.

U.S. Published Patent No. 2008/0245357, Inventor Meetheru et al, published on Oct. 9, 2008, discloses an outdoor grill with interchangeable modular cooking assemblies.

U.S. Published Patent No. 2011/0094494, Inventor Malumyan, published on Apr. 28, 2011, discloses a portable combination gas and charcoal barbecue grill.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a combination gas and ceramic cooking grill. The combination grill is one integrally formed structure in one embodiment. In an alternative embodiment, the combination grill includes two separate structures that are adapted to be joined one to another.

In at least one embodiment, a combination gas and ceramic grill includes: a grill housing; a gas grill head disposed within the grill housing; and a ceramic grill disposed within the grill housing.

In at least one embodiment of the combination gas and ceramic grill, the grill housing is defined as a single structure and adapted to house the gas grill head and the ceramic grill.

In at least one embodiment of the combination gas and ceramic grill, the grill housing is comprised of a first portion adapted to house the gas grill head and a second portion adapted to house the ceramic grill, and wherein the first portion and second portion are both separable, one from another, and, alternatively, attachable, one to another, thereby adapted to provide two housing combinations: a single housing structure and, as operatively selected by a user, a pair of housing structures.

In at least one embodiment of the combination gas and ceramic grill, the ceramic grill is a removable Kamado-style ceramic grill.

In at least one embodiment of the combination gas and ceramic grill, the grill housing comprises a roll cart having a plurality of wheels and within which the both of the gas grill head and the ceramic grill are housed.

In at least one embodiment, the combination gas and ceramic grill further includes a plurality of burners disposed within the gas grill head.

In at least one embodiment, the combination gas and ceramic grill also includes a flame tamer disposed within the gas grill head.

In at least one embodiment, the combination gas and ceramic grill further includes at least one flash tube disposed within the gas grill head and adapted to interconnect the plurality of burners.

In at least one embodiment, the combination gas and ceramic grill further includes a cooking grate disposed within the gas grill head.

In at least one embodiment, the combination gas and ceramic grill also includes a cooking grate disposed within the ceramic grill.

In at least one embodiment, the combination gas and ceramic grill further includes at least one flip-up removable side shelve disposed upon a side of the grill housing.

In at least one embodiment, the combination gas and ceramic grill further includes a grease tray disposed within the gas grill head.

In at least one embodiment, the combination gas and ceramic grill further includes a warming rack disposed within the gas grill head.

In at least one embodiment, the combination gas and ceramic grill further includes a warming rack disposed within the ceramic grill.

In at least one embodiment, the combination gas and ceramic grill further includes a sear burner.

In at least one embodiment, the combination gas and ceramic grill further includes a plurality of pads adapted to receive the ceramic grill and to protect the grill housing from the heat of the ceramic grill.

In at least one embodiment, a grill includes: a grill housing; a gas grill head disposed within the grill housing; a removable Kamado-style ceramic grill disposed within the grill housing; a plurality of burners disposed within the gas grill head; a flame tamer disposed within the gas grill head; at least one flash tube disposed within the gas grill head and adapted to interconnect the plurality of burners; a cooking grate disposed within the gas grill head; and a warming rack disposed within the gas grill head. In this embodiment, the grill housing is a single structure. In this embodiment, the grill housing comprises a roll cart within which the both of the gas grill head and the ceramic grill are housed. In at least one embodiment of the grill, a sear burner is also included.

In at least one embodiment, a grill includes: a grill housing; a gas grill head disposed within the grill housing; a removable Kamado-style ceramic grill disposed within the grill housing; a plurality of burners disposed within the gas grill head; a flame tamer disposed within the gas grill head; at least one flash tube disposed within the gas grill head and adapted to interconnect the plurality of burners; a cooking grate disposed within the gas grill head; and a warming rack disposed within the gas grill head. In this embodiment, the grill housing is comprised of a first roll cart adapted to house the gas grill head and a second roll cart adapted to house the ceramic grill, and wherein the first roll cart and the second roll cart are both separable, one from another, and attachable, one to another, thereby adapted to provide two housing combinations: a single housing structure and operatively a pair of housing structures. In at least one embodiment of the grill, a sear burner is also included.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view of a gas and ceramic grill combination, illustrating, in particular, an assembled version, according to an embodiment of the technology described herein;

FIG. 2 is a rear perspective view of a gas and ceramic grill combination, illustrating, in particular, an assembled version, according to an embodiment of the technology described herein;

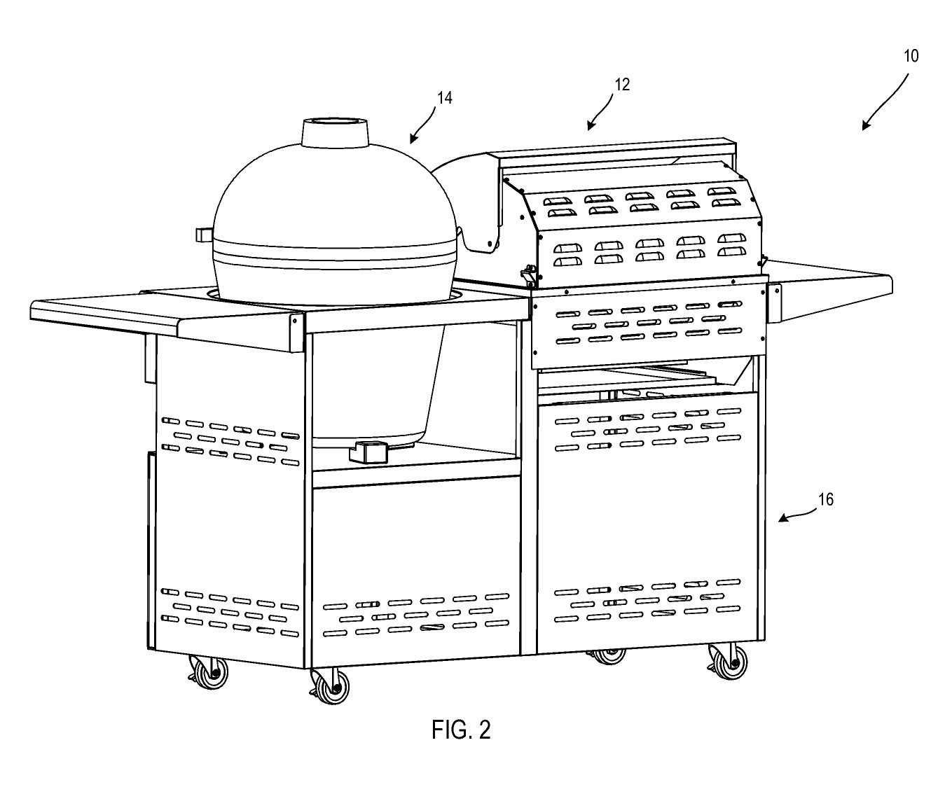

FIG. 3 is a perspective view of a gas and ceramic grill combination, illustrating, in particular, an assembled version with hinged elements opened, according to an embodiment of the technology described herein;

FIG. 4 is a partially exploded view of a gas and ceramic grill combination, illustrating, in particular, major elements, according to an embodiment of the technology described herein;

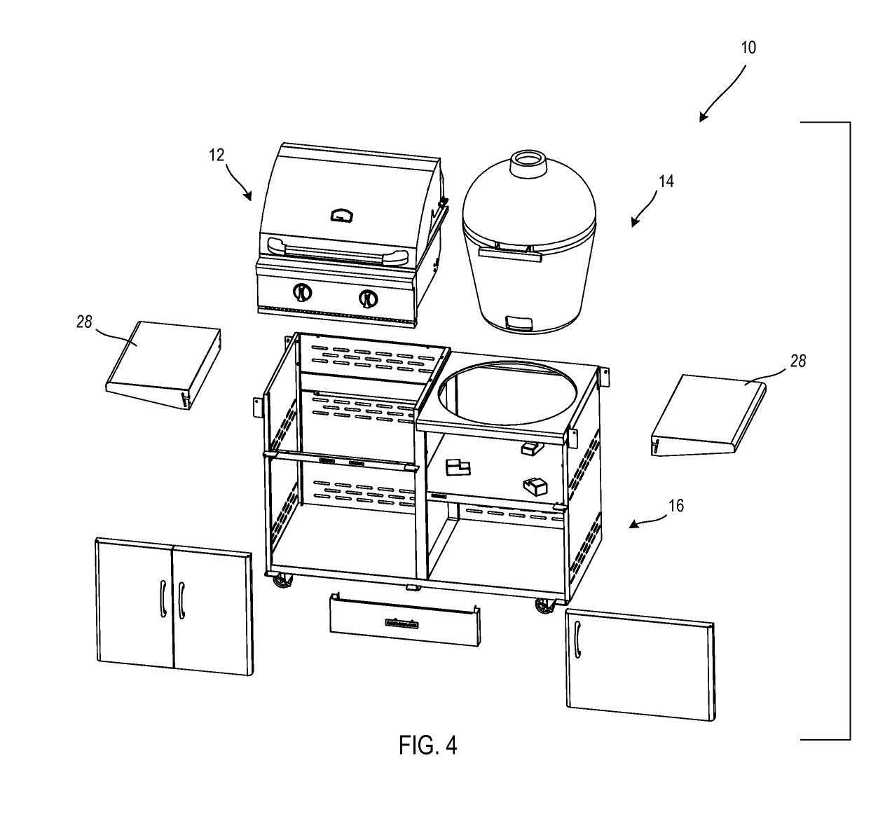

FIG. 5 is a partially exploded view of a gas and ceramic grill combination, illustrating, in particular, an alternate view of selected elements, according to an embodiment of the technology described herein;

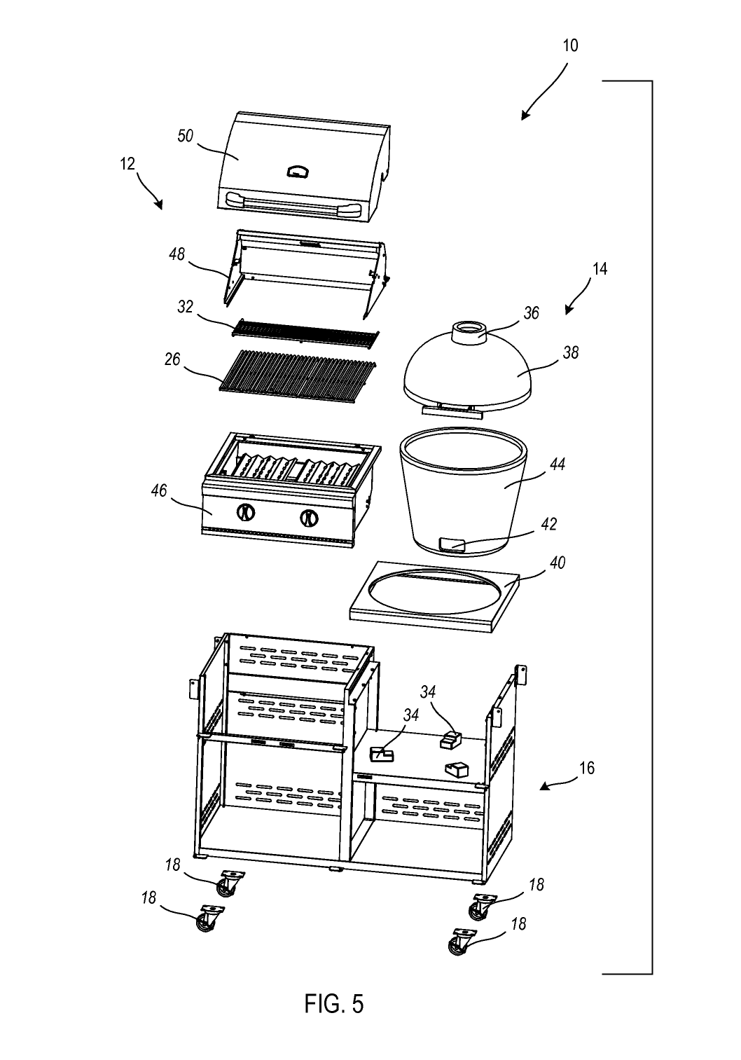

FIG. 6 is a partially exploded view of a gas and ceramic grill combination, illustrating, in particular, major elements of the gas burner assembly, according to an embodiment of the technology described herein;

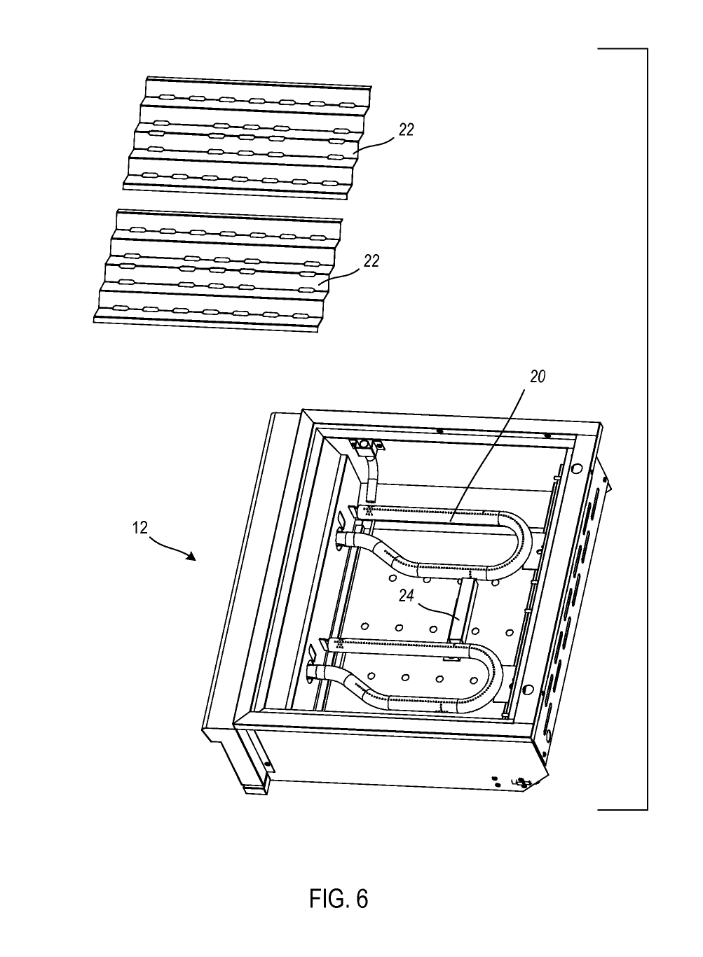

FIG. 7 is a partially exploded view of a gas and ceramic grill combination, illustrating, in particular, an alternate view of major elements of the gas burner assembly, according to an embodiment of the technology described herein;

FIG. 8 illustrates a front perspective view of separable frames for the gas grill and Kamado-style grill, according to an embodiment of the technology described herein;

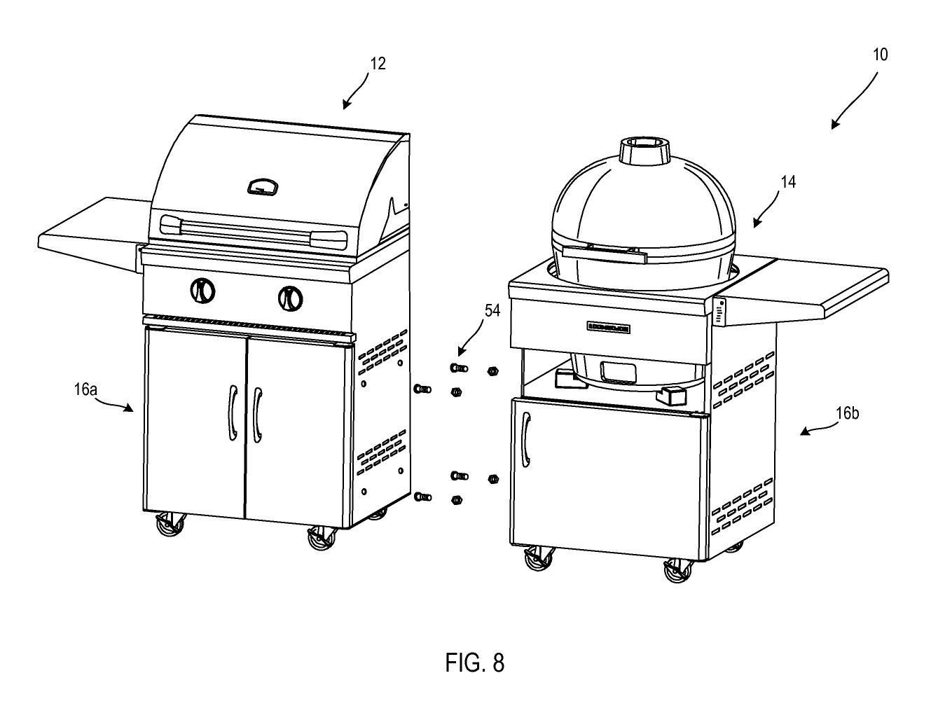

FIG. 9 illustrates a rear perspective view of FIG. 8;

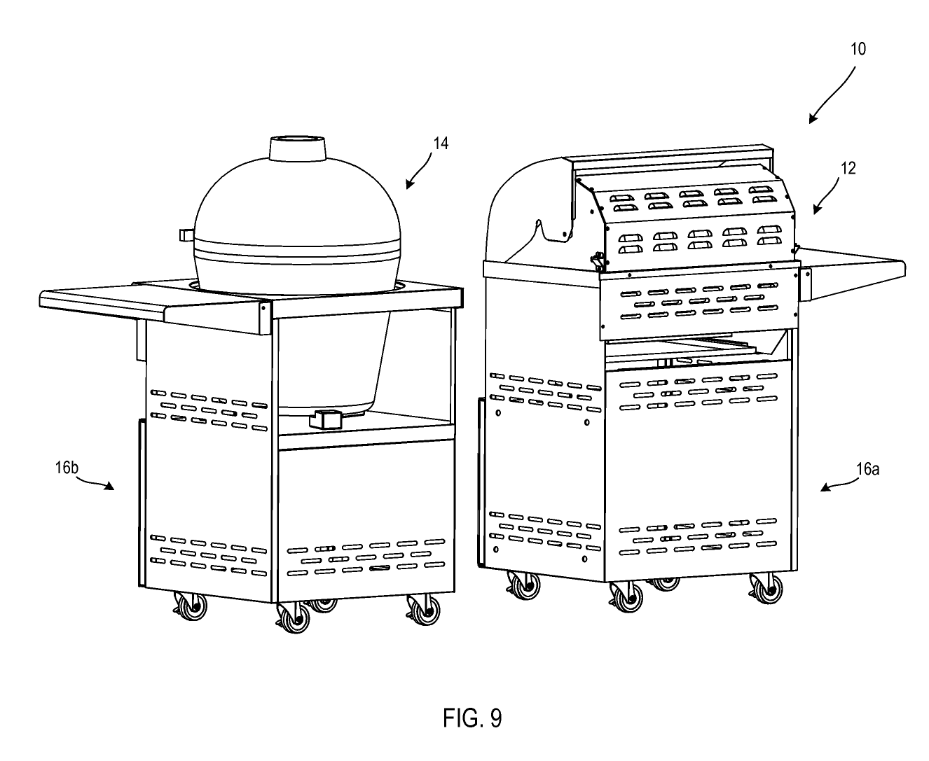

FIG. 10 illustrates top perspective view of the embodiment depicted in FIG. 8; and

FIG. 11 illustrates partially exploded view of the embodiment depicted in FIG. 8.

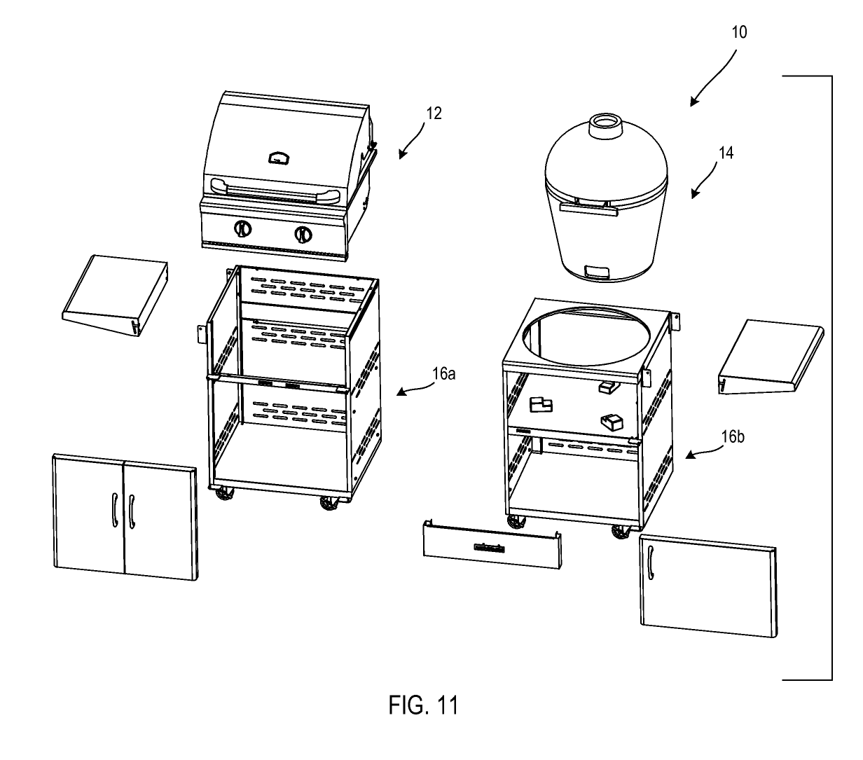

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology and are intended to be covered by subsequent claims.

### DETAILED DESCRIPTION OF THE INVENTION

In various exemplary embodiments, the technology described herein provides a combination gas and ceramic cooking grill 10. The combination grill 10 is one integrally formed structure in one embodiment. In an alternative embodiment, the combination grill 10 includes two separate structures that are adapted to be joined one to another, and likewise separated one from another as desired by a user.

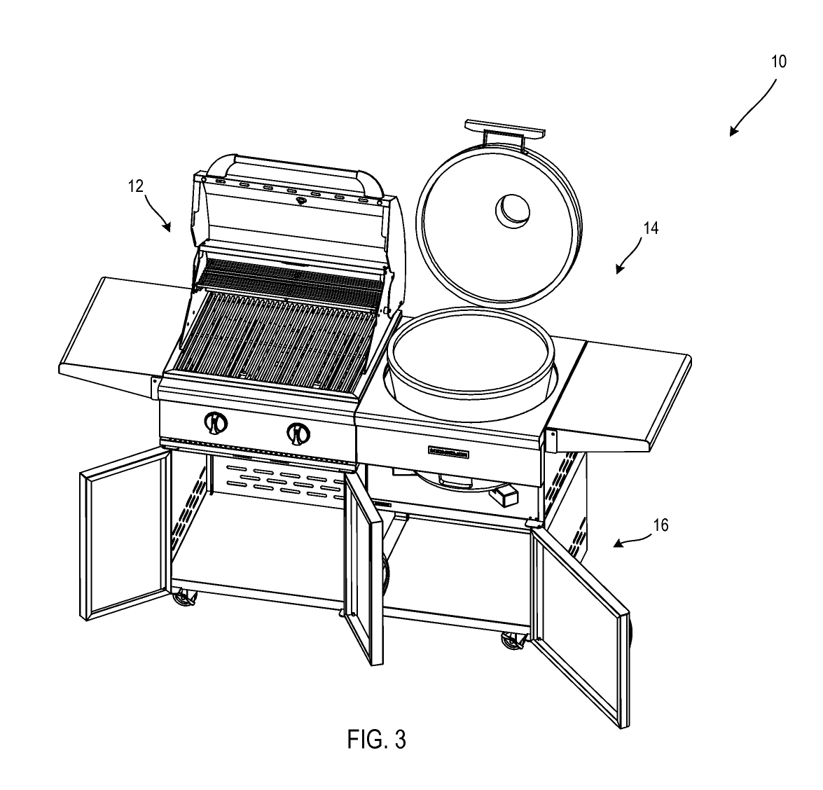

The combination gas and ceramic grill 10 includes a grill housing 16. In at least one embodiment, the combination gas and ceramic grill 10 is made primarily of stainless steel, such as 304 stainless steel, for example. Within the grill housing 16, much storage space is provided (as depicted in FIG. 3, for example). By way of example, the combination gas and ceramic grill 10 can be provided in common grill sizes such as a 26″ 2-burner grill and a 32″ 3-burner grill sizes.

The combination gas and ceramic grill 10 includes a gas grill head 12 disposed within the grill housing 16. The gas grill head 12 is adapted to use liquid propane (LP) but can be adapted with a natural gas conversion kit to utilize natural gas (NG). The gas grill head 12, having a grill head base 46, back 48, and lid 50, is made primarily of stainless steel, such as 304 stainless steel, for example. The lid 50 can include a handle and a temperature gauge.

The combination gas and ceramic grill 10 includes a ceramic grill 14 disposed within the grill housing 16. The ceramic grill 14 is made of high fire heat resistant ceramics and includes a resistant ceramic coating.

By way of example, and not of limitation, the ceramic grill 14 also includes, in various embodiments, a fire grate and top vent 36 on the hinged lid, which can be powder-coated cast iron. In at least one embodiment, the top vent 36 is a dual-disc, cast-iron vent system. This unique, dual-disc top vent 36 includes a top disc (daisy wheel) which is used for low-temperature cooking, and a bottom disc which is used for grilling, baking, roasting and searing. This system gives you exceptional temperature control.

By way of example, and not of limitation, the ceramic grill 14 also includes, in various embodiments, a fire box or fire ring 40 having high fire heat-resistant ceramics, such as 34. These can also provide protection to adjacent components from exposure to excessive heat.

By way of example, and not of limitation, the ceramic grill 14 also includes, in various embodiments, a draft door 42, disposed upon the ceramic grill base 44, adapted for air circulation, and adjustable as needed to achieve the appropriate and desired air flow. In use, the ceramic grill 14, and its ceramic construction and unique shape, along with using lump charcoal, mean moister meats and wood-fire flavor.

Additionally, the insulative properties of the ceramic grill 14, and with the ability of lump charcoal to generate significant heat, one can achieve temperatures up to 750° F. With this intense high temperature heat, one can sear a steak, such that it will come off sizzling, just like it does at the high-end steak houses.

Furthermore, with the ability to control temperature and thanks to the long-burning stamina of lump charcoal, one can use the ceramic grill 14 as a smoker or a slow cooker (it will maintain low temps for up to 12 hours without adding lump charcoal).

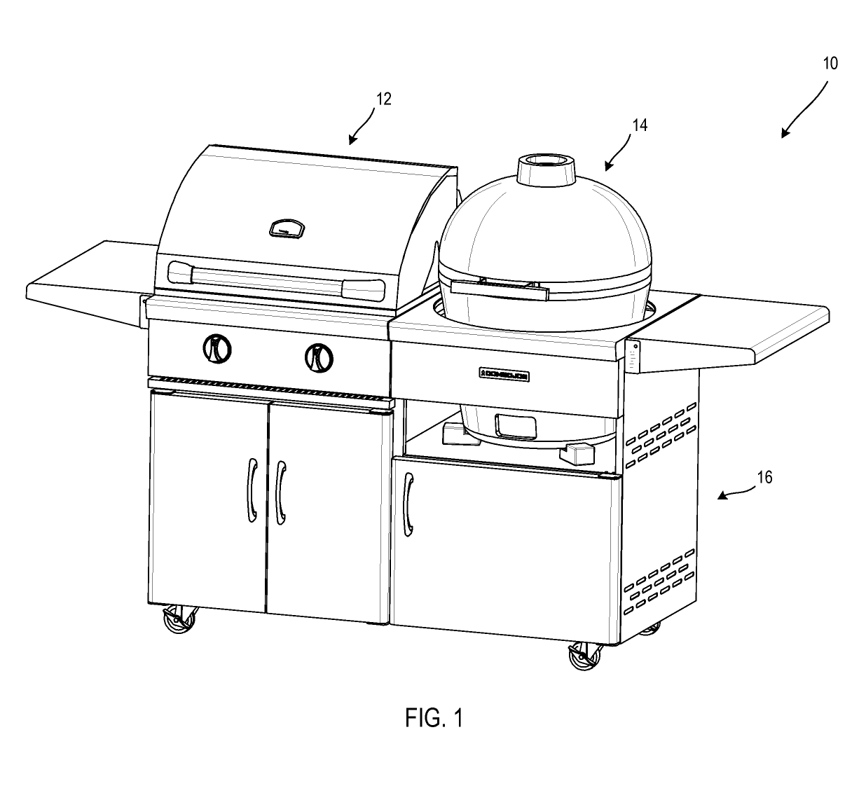

In at least one embodiment of the combination gas and ceramic grill 10, the grill housing 16 is defined as a single structure (such as that depicted in FIG. 1, for example) and is adapted to house the gas grill head 12 and the ceramic grill 14. The ceramic grill 14 is adapted to attain and sustain very high temperatures, and can do so for an extended period of time for some cooking applications as determined by the user or chef.

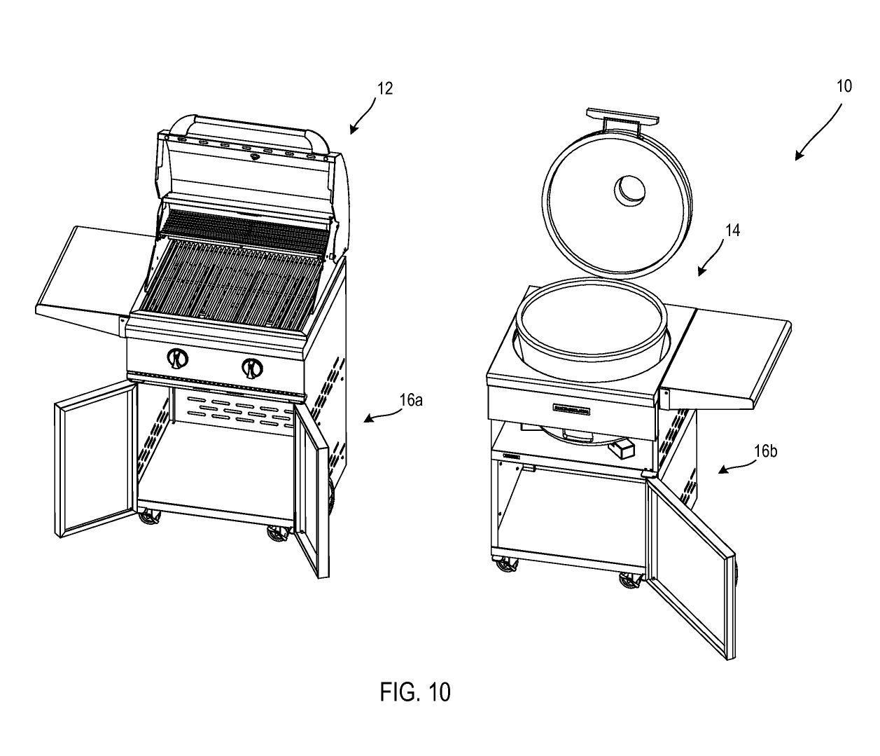

In at least one embodiment of the combination gas and ceramic grill 10, the grill housing 16 is comprised of a first portion 16a adapted to house the gas grill head 12 and a second portion 16b adapted to house the ceramic grill 14. In this embodiment, the first portion 16a and the second portion 16b are both separable, one from another. Additionally, in this embodiment, the first portion 16a and the second portion 16b are both attachable, one to another. The combination gas and ceramic grill 10 is thereby adapted to provide two housing combinations: a single housing structure (such as that depicted in FIG. 1, for example) and, as operatively selected by a user, a pair of housing structures (such as that depicted in FIG. 10, for example). Mounting hardware 54 is utilized to combine the first portion 16a and the second portion 16b.

In at least one embodiment of the combination gas and ceramic grill 10, the ceramic grill 16 is a removable Kamado-style ceramic grill (as depicted in the Figures). Historically, a kamado is a traditional Japanese wood or charcoal fired earthen vessel used as a stove or oven.

In at least one embodiment of the combination gas and ceramic grill 10, the grill housing 16 comprises a roll cart (as depicted) having a multiplicity of wheels 18 and within which the both of the gas grill head 12 and the ceramic grill 14 are housed. By way of example, the wheels 18 can be locking casters.

In at least one embodiment, the combination gas and ceramic grill 10 further includes a multiplicity of burners 20 disposed within the gas grill head 12. The number and placement and type of burners 20 is varied in alternative embodiments.

In at least one embodiment, the combination gas and ceramic grill 10 also includes a flame tamer 22 disposed within the gas grill head 12. Any one or more flame tamer 22 utilized is placed over the multiplicity of burners 20 disposed within the gas grill head 12. A flame tamer 22 can provide a shield to direct flame contact with food items being cooked, or lessen the amount of flame.

In at least one embodiment, the combination gas and ceramic grill 10 further includes at least one flash tube 24 disposed within the gas grill head 12. Each flash tube 24 is adapted to interconnect and fluidly couple the multiplicity of burners 20. Each flash tube 24 allows for the passage of LP or NG between burners 20 when opened operatively by a user through the control knobs.

In at least one embodiment, the combination gas and ceramic grill 10 further includes a cooking grate 26 disposed within the gas grill head 12. In at least one embodiment, and by way of example and not of limitation, the cooking grate is 8 mm 304 stainless steel.

In at least one embodiment, the combination gas and ceramic grill also includes a cooking grate, such as 26 but having a different shape adapted for the Kamado-style, disposed within the ceramic grill 14.

In at least one embodiment, the combination gas and ceramic grill 10 further includes at least one flip-up removable side shelve 28 disposed upon a side of the grill housing 16. As depicted in the Figures, a flip-up removable side shelve 28 is utilized on each end of the combination gas and ceramic grill 10.

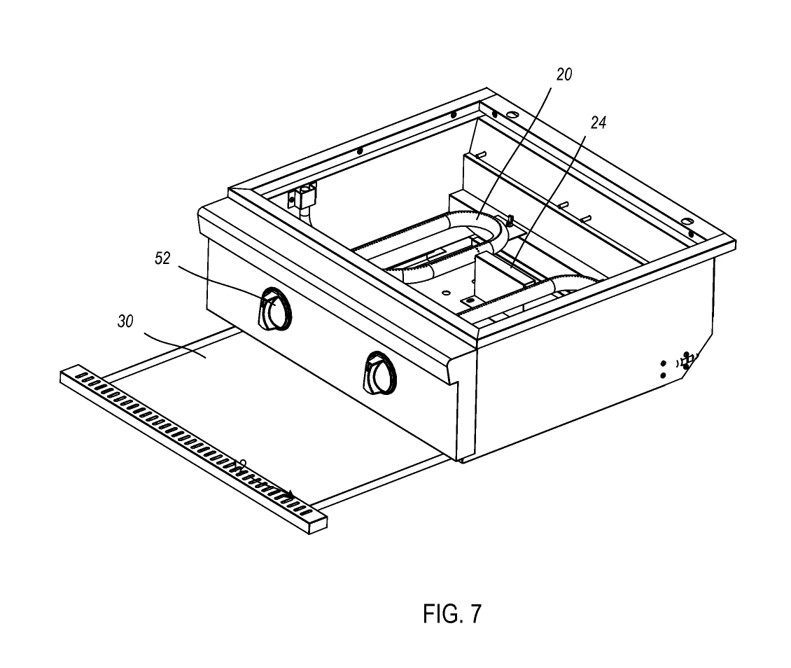

In at least one embodiment, the combination gas and ceramic grill 10 further includes a grease tray 30 disposed within the gas grill head 12. The grease tray 30 is depicted in an extended position in FIG. 7. Additionally, control knobs, 52, that can be utilized both for ignition, flame adjustment, temperature selection, and so forth, are depicted.

In at least one embodiment, the combination gas and ceramic grill 10 further includes a warming rack 32 disposed within the gas grill head 12. A warming rack 32 is utilized to provide a location higher than the cooking grate 26, and having presumably less direct heat to keep items warm.

In at least one embodiment, the combination gas and ceramic grill further includes a warming rack, such as 32 but having a different shape adapted for the Kamado-style, disposed within the ceramic grill 14.

In at least one embodiment, the combination gas and ceramic grill 10 further includes a sear burner. The sear burner is utilized in place of a tube burner 20. The sear burner 20 is adapted to sear a food item.

In at least one embodiment, the combination gas and ceramic grill 10 further includes a multiplicity of pads 34 adapted to receive the ceramic grill 14 and to protect the grill housing 16 from the heat of the ceramic grill 14. The pads 34 may be ceramics or other heat resistant elements.

In at least one embodiment, a grill 10 includes: a grill housing 16; a gas grill head 12 disposed within the grill housing 16; a removable Kamado-style ceramic grill 14 disposed within the grill housing 16; a plurality of burners 20 disposed within the gas grill head 12; a flame tamer 22 disposed within the gas grill head 12; at least one flash tube 24 disposed within the gas grill head 12 and adapted to interconnect the plurality of burners 20; a cooking grate 26 disposed within the gas grill head 12; and a warming rack 32 disposed within the gas grill head 12.

In this embodiment, the grill housing 16 is a single structure. In this embodiment, the grill housing 16 comprises a roll cart within which the both of the gas grill head 12 and the ceramic grill 14 are housed. In at least one embodiment of the grill 10, a sear burner (in place of 20) is also included.

In at least one embodiment, a grill includes 10: a grill housing 16; a gas grill head 12 disposed within the grill housing 16; a removable Kamado-style ceramic grill 14 disposed within the grill housing 16; a plurality of burners 20 disposed within the gas grill head 12; a flame tamer 22 disposed within the gas grill head 12; at least one flash tube 24 disposed within the gas grill head 12 and adapted to interconnect the plurality of burners 20; a cooking grate 26 disposed within the gas grill head 12; and a warming rack 32 disposed within the gas grill head 12.

In this embodiment, the grill housing 16 is comprised of a first roll cart 16a adapted to house the gas grill head 12 and a second roll cart 16b adapted to house the ceramic grill 14. The first roll cart 16a and the second roll cart 16b are both separable, one from another, and attachable, one to another, thereby adapted to provide two housing combinations: a single housing structure (such as that depicted in FIG. 1, for example) and operatively a pair of housing structures (such as that depicted in FIG. 10, for example). In at least one embodiment of the grill, a sear burner (in place of 20) is also included.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosed technology and are intended to be covered in the appended claims.

What is claimed is:

1. A combination gas and ceramic grill comprising:
a grill housing;
a gas grill head disposed within the grill housing; and
a ceramic grill disposed within the grill housing.

2. The combination gas and ceramic grill of claim 1, wherein the grill housing is defined as a single structure and adapted to house the gas grill head and the ceramic grill.

3. The combination gas and ceramic grill of claim 1, wherein the grill housing is comprised of a first portion adapted to house the gas grill head and a second portion adapted to house the ceramic grill, and wherein the first portion and second portion are both separable, one from another, and, alternatively, attachable, one to another, thereby adapted to provide two housing combinations:
a single housing structure and, as operatively selected by a user, a pair of housing structures.

4. The combination gas and ceramic grill of claim 1, wherein the ceramic grill is a removable Kamado-style ceramic grill.

5. The combination gas and ceramic grill of claim 1, wherein the grill housing comprises a roll cart having a plurality of wheels and within which the both of the gas grill head and the ceramic grill are housed.

6. The combination gas and ceramic grill of claim 1, further comprising:
a plurality of burners disposed within the gas grill head.

7. The combination gas and ceramic grill of claim 1, further comprising:
a flame tamer disposed within the gas grill head.

8. The combination gas and ceramic grill of claim 6, further comprising:
at least one flash tube disposed within the gas grill head and adapted to interconnect the plurality of burners.

9. The combination gas and ceramic grill of claim 1, further comprising:
a cooking grate disposed within the gas grill head.

10. The combination gas and ceramic grill of claim 1, further comprising:
a cooking grate disposed within the ceramic grill.

11. The combination gas and ceramic grill of claim 1, further comprising:
at least one flip-up removable side shelve disposed upon a side of the grill housing.

12. The combination gas and ceramic grill of claim 1, further comprising:
a grease tray disposed within the gas grill head.

13. The combination gas and ceramic grill of claim 1, further comprising:
a warming rack disposed within the gas grill head.

14. The combination gas and ceramic grill of claim 1, further comprising:
a warming rack disposed within the ceramic grill.

15. The combination gas and ceramic grill of claim 1, further comprising:
a sear burner.

16. The combination gas and ceramic grill of claim 1, further comprising:
a plurality of pads adapted to receive the ceramic grill and to protect the grill housing from the heat of the ceramic grill.

17. A grill comprising:
a grill housing;
a gas grill head disposed within the grill housing;
a removable Kamado-style ceramic grill disposed within the grill housing;
a plurality of burners disposed within the gas grill head;
a flame tamer disposed within the gas grill head;
at least one flash tube disposed within the gas grill head and adapted to interconnect the plurality of burners;
a cooking grate disposed within the gas grill head; and
a warming rack disposed within the gas grill head;
wherein the grill housing is a single structure;
wherein the grill housing comprises a roll cart within which the both of the gas grill head and the ceramic grill are housed.

18. The grill of claim 17, further comprising
a sear burner.

19. A grill comprising:
a grill housing;
a gas grill head disposed within the grill housing;
a removable Kamado-style ceramic grill disposed within the grill housing;
a plurality of burners disposed within the gas grill head;
a flame tamer disposed within the gas grill head;
at least one flash tube disposed within the gas grill head and adapted to interconnect the plurality of burners;
a cooking grate disposed within the gas grill head; and
a warming rack disposed within the gas grill head;
wherein the grill housing is comprised of a first roll cart adapted to house the gas grill head and a second roll cart adapted to house the ceramic grill, and wherein the first roll cart and the second roll cart are both separable, one from another, and attachable, one to another, thereby adapted to provide two housing combinations: a single housing structure and operatively a pair of housing structures.

20. The grill of claim 19, further comprising:
a sear burner.
